(19) United States
(12) Patent Application Publication
(10) Pub. No.: US 2008/0201224 A1
(43) Pub. Date: Aug. 21, 2008

(54) METHOD AND APPARATUS FOR PROCESSING REWARDS

(76) Inventors: Nina Castro Owens, East Setauket, NY (US); Richard Stephen Kravchuk, Stamford, CT (US)

Correspondence Address: BUCKLEY, MASCHOFF & TALWALKAR LLC, 50 LOCUST AVENUE, NEW CANAAN, CT, 06840, US

(21) Appl. No.: 11/939,157

(22) Filed: Nov. 13, 2007

Related U.S. Application Data
(60) Provisional application No. 60/858,643, filed on Nov. 13, 2006.

(51) Int. Cl. G06Q 30/00

(52) U.S. Cl. 705/14

(57) ABSTRACT

Methods, systems, apparatus, computer program code and means for processing reward transactions are provided including receiving, from a point of interaction associated with a merchant, an authorization request message identifying a requested purchase transaction, the authorization request message including data identifying a payment account identifier and a purchase amount. Authorizing the purchase transaction, and receiving, from the merchant, merchant reward data associated with the purchase transaction, and updating a pooled rewards database entry associated with the consumer.

### CROSS-REFERENCE TO RELATED APPLICATION

This application claims the benefit of and priority to provisional patent application Ser. No. 60/858,643, filed Nov. 13, 2006, the contents of which are hereby incorporated by reference herein in their entirety.

### BACKGROUND

Embodiments disclosed herein relate to payment systems. In particular, some embodiments relate to methods, apparatus, systems, means and computer program products for processing rewards, including rewards processing at point of sale (“POS”) locations.

Payment card loyalty or rewards programs have been in wide spread use for some time. Most consumers who hold payment cards participate in some form of loyalty program, including merchant-specific frequent buyer programs, airline mileage programs, or the like. In general, these programs are successful, as many consumers who participate in loyalty or reward programs indicate that their participation in the programs has an impact on their purchasing decisions.

Unfortunately, the ubiquity of these programs has led to dilution of their impact. With so many programs, and so little differentiation, customer's behaviors are not directly driven by the programs. As a result, many customers do not actively participate in loyalty programs even after they have enrolled.

Because each rewards program has a different access or identifying device or code, customers are forced to carry multiple access devices or codes with them. Many customers do not participate in all of the rewards programs they are eligible to participate in because they forget to carry the access device, forget their access code, or simply do not want to register to participate in another program that requires use of another device or code.

Further, the reward delivery mechanism for most loyalty programs has primarily been the use of store coupons, statement inserts or other printed coupons that require a customer to redeem the coupon in a future purchase. It would be desirable to reduce the barriers to consumers to make it easier for them to participate and receive awards. It would further be desirable to provide systems and methods that allow merchants to easily deploy and administer reward programs.

### BRIEF DESCRIPTION OF THE DRAWINGS

Features and advantages of some embodiments of the present invention, and the manner in which the same are accomplished, will become more readily apparent upon consideration of the following detail description of the invention taken in conjunction with the accompanying drawings, which illustrate preferred and exemplary embodiments and which are not necessarily drawn to scale, wherein:

FIG. 1 is a block diagram illustrating a pooled rewards system according to some embodiments of the present invention.

FIG. 2 is a flow diagram illustrating a cardholder record creation process according to some embodiments of the present invention.

FIG. 3 is a flow diagram illustrating a pooled rewards transaction process according to some embodiments of the present invention.

FIG. 4 is a flow diagram illustrating a pooled rewards redemption process according to some embodiments of the present invention.

FIG. 5 is a further block diagram illustrating a pooled rewards system and transaction according to some embodiments of the present invention.

FIG. 6 is a further block diagram illustrating a pooled rewards system and transaction according to some embodiments of the present invention.

FIG. 7 is a further block diagram illustrating a pooled rewards system and transaction according to some embodiments of the present invention.

FIG. 8 is a swim lane diagram illustrating features of different cardholder pooled rewards transactions pursuant to some embodiments of the present invention.

FIG. 9 is a further swim lane diagram illustrating features of different cardholder pooled rewards transactions pursuant to some embodiments of the present invention.

### DETAILED DESCRIPTION

Applicants have recognized that there is a need for methods, systems, apparatus, means and computer program products for processing rewards such that data from different merchant reward or loyalty programs are pooled along with payment card transaction data, thereby allowing payment cardholders to use their payment cards to identify their participation in a merchant loyalty or reward program. Applicants have further recognized a need for methods, systems, apparatus, means and computer program products for processing merchant rewards or loyalty programs at transaction point of sale locations such that reward program verification and validation as well as the identification of general and specific merchant and product/service rebates, coupons and discounts is performed during the course of a transaction at a point of sale location. Further still, in some embodiments, applicants have recognized a need for an ability to issue and/or redeem general and specific merchant and product/service rebates, coupons, and discounts during a point of sale transaction.

In some embodiments, methods, systems, apparatus, means and computer program products are provided to deliver real time rewards messaging and statement rebates. In some embodiments, methods, systems, apparatus, means and computer program products are provided to deliver real time discounts at the point of sale. In some embodiments, methods, systems, apparatus, means and computer program products are provided to allow reward point redemption at the point of sale.

Although features will be described in an illustrative example with transactions conducted in the U.S., embodiments may be used in any region or cross-regions.

These and other features will be discussed in further detail below, by describing exemplary processes according to some embodiments of the invention.

A number of terms will be used to describe features of some embodiments. For example, the term “POS” will be used to refer to a point of sale, point of interaction, or point of transaction location, such as a physical POS device (e.g., such as a Verifone® transaction terminal or any similar device allowing payment card data to be read from a magnetic stripe, a chip, keyed in, etc). As used herein, the term “POS” also includes Internet or telephone points of sale as well as physical points of sale. The term “POS” may be used interchangeably herein with the term “point of interaction” or “POI”.

The term “payment card” will be used to refer to a payment device such as a credit card, a debit card, a stored value card, or other device that may be used by a cardholder to access funds or credit. In the transaction flows described herein, each payment card will be associated with a specific payment processing network—particularly the MasterCard International processing network. That is, each payment card has a primary account number including data indicating that the payment card is associated with the MasterCard network, such that some or all of the transactions involving that payment card are processed using the MasterCard network. Embodiments may be used with other networks, including networks operated by Visa®, American Express®, or the like (including regional or local networks). As used herein, the example payment processing network is the Banknet® network operated by MasterCard International.

As used herein, the term “acquirer” will refer to the financial institution or processor that has a merchant acquiring relationship with a merchant (and may be, for example, the financial institution that a particular merchant has a banking relationship with). As used herein, the term “issuer” will refer to the financial institution that issued a particular payment card to a cardholder. Those skilled in the art will appreciate that a number of payment cardholders, payment cards, merchants, acquirers, and issuers will be involved in a payment network.

As used herein, transaction messages including an “authorization request” or “0100” message and an “authorization response” or “0110” message are used to refer to messages passed between participating devices in the network for each transaction. Those skilled in the art will appreciate that other types of authorization message formats may be used.

Prior to discussing features of some embodiments, a brief illustrative example may be helpful in understanding features of some embodiments. In the illustrative example, a cardholder has a payment card issued by “Big Bank”. The cardholder is also a member of a number of merchant loyalty programs, and has separate loyalty cards and identifiers for a large coffee chain, a donut chain, a pharmacy, and a supermarket chain. She is also a member of her bank's payment card rewards program. Pursuant to some embodiments, each of her rewards points can be “pooled” so that reward points she earns for purchases at the coffee chain, donut chain, pharmacy, and supermarket chain can be aggregated into an overall “pooled” balance allowing her to earn rewards more quickly.

Pursuant to some embodiments, when the cardholder uses her BigBank payment card to purchase items at the coffee chain, the reward points she earns from the coffee chain are communicated (either in real time or in a batch transaction) to a pooled rewards system. The pooled rewards system performs a reward point conversion to convert the coffee chain reward points into pooled reward points (or a dollar equivalent). Similar reward point communications and conversions are performed each time the cardholder uses her BigBank payment card at any of the participating merchant locations. In this manner, the cardholder can quickly earn pooled reward points. Further, pursuant to some embodiments, the cardholder can still choose to redeem reward points from the individual merchant loyalty programs (for example, the cardholder may choose to redeem her coffee chain reward points through the coffee chain loyalty program rather than as pooled reward points through the pooled rewards program). In this manner, the cardholder has the greatest flexibility and choice in redeeming and earning reward points. Further benefits and features will become apparent to those skilled in the art upon reading the following disclosure.

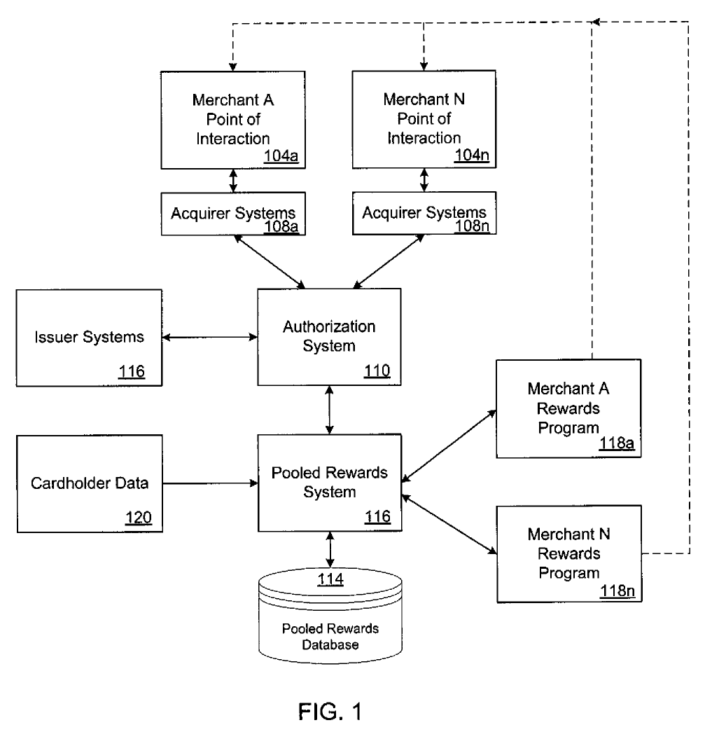

Features of some embodiments will now be described in further detail by first referring to FIG. 1, where a pooled rewards system 100 is shown. As depicted, a number of entities and systems operate in cooperation to create, update and process pooled rewards pursuant to embodiments of the present invention. The pooled rewards system 100, as depicted, includes components to facilitate payment transactions which may be reward-earning (including, for example, the points earned in a transaction at a participating merchant location, for example). These components include merchant points of interaction or POS devices 104a-n, acquirer systems 108a-n, authorization systems 110, issuer systems 112, pooled rewards system 116 and pooled rewards database 114. The pooled rewards system 100, as depicted, includes components to create and update pooled rewards pursuant to some embodiments (including, for example, the creation of a new pooled rewards record for participating cardholders, and the updating and information management of merchant rewards programs with the pooled rewards system). These components include cardholder data sources 120, merchant rewards program data sources 118a-n, pooled rewards system 116 and pooled rewards database 114. Each of these components will be described further in more detail below.

Pursuant to some embodiments, a pooled rewards system 116 is in communication with (or integrated with) authorization systems 110. In one illustrative example, authorization systems 110 include the BankNet® network operated by MasterCard International®, which serves to facilitate authorizations of payment transactions involving MasterCard branded payment cards.

Those skilled in the art will recognize that other authorization networks are also known and used for processing payment transactions (e.g., such as the payment card authorization networks operated by Visa International Service Association® or American Express®). Authorization systems 110 receive payment authorization request messages from acquirer systems 108a-n, and processes the authorization request messages to authorize or decline a payment transaction. In some embodiments, authorization request messages may be routed to issuer systems 112 for authorization processing. Those skilled in the art will also appreciate that authorization systems 110 may also include a transaction clearing and settlement function; however, for the purpose of this disclosure, the systems 110 will simply be referred to as the authorization systems.

Embodiments as illustrated in FIG. 1 also involve a pooled rewards system 116 in communication with authorization systems 110 and a pooled rewards databases 14. Pursuant to the embodiment of FIG. 1, pooled rewards database 114 stores data associated with participating cardholders (e.g., received from cardholder data source 120), and one or more merchant rewards programs (e.g., received from merchant rewards data sources 118a-n). For example, pooled rewards database 114 may store a unique customer identifier for each cardholder participating in a pooled rewards program. The unique customer identifier is used to identify transactions involving the cardholder identified by the unique customer identifier so that the cardholder's pooled rewards data may be appropriately updated. Pooled rewards database 114 also stores data from one or more merchant rewards programs, including, for example, reward point conversion data that is used to convert between a merchant's reward point and a pooled reward point. For example, a merchant may specify that each of its reward points is valued at $0.10. The pooled reward points may be valued at the same, or a different value, and the conversion information is used to convert between the two point values.

Pooled rewards database 114 also stores current merchant reward program balance information for individual cardholders who participate in both the pooled rewards program and the merchants rewards program. This information may be provided substantially in real-time from merchants (e.g., as part of a purchase transaction) or on a batch basis (e.g., nightly or the like) directly from merchant rewards systems. In this manner, the pooled rewards database 114 is able to store data about: each cardholder (including a unique identifier uniquely identifying the cardholder), each cardholder's pooled reward account balance, information identifying each merchant reward program the cardholder is a member of, each cardholder's current merchant reward account point balance, and information allowing conversion between each merchant reward account point balance and the pooled reward account balance.

Pursuant to some embodiments, merchant rewards information may be communicated from merchant rewards program data sources 118 and pooled rewards system 116 substantially in real-time during the course of a transaction (e.g., represented by the dashed lines between merchant rewards program data sources 118 and merchant point of interaction 104). Pursuant to some embodiments, this information is communicated using authorization and other messages from the point of interaction to the pooled rewards system 116 during a transaction. In some embodiments, merchant rewards information may be communicated from merchant rewards program data sources 118 and pooled rewards system 116 as batch transactions after the completion of purchase transactions. Both of these embodiments will be discussed further below.

Further details of the interaction between payment transactions (involving merchant POS devices 104, acquirer systems 108, issuer systems 112 and authorization systems 110) and pooled rewards system 116 will be described further below. An illustrative example of the type of data and data structure of pooled rewards database 114 will also be described below.

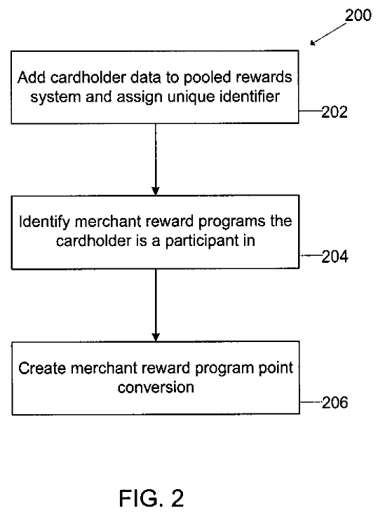

Reference is now made to FIG. 2, where a flow diagram is shown illustrating a cardholder record creation process 200 pursuant to some embodiments. As discussed in the illustrative example above, a payment card holder or other account holder may participate in a pooled rewards system pursuant to the present invention once the payment card holder has been added to (or registered with) the pooled rewards system. Cardholder record creation process 200 describes one embodiment for adding a cardholder to the pooled rewards system. Process 200 may be performed under control of software associated with pooled rewards system 116 and may result in the creation of data stored in pooled rewards database 118.

As shown in FIG. 2, processing begins at 202 where cardholder data is added to the pooled rewards system, and a unique identifier is assigned to uniquely identify the cardholder. Processing at 202 may be accomplished in a number of different ways. For example, an issuer of payment cards may designate a number of payment card accounts as participating in a pooled rewards system (e.g., by specifying an account range or specific account numbers associated with the participating accounts). As another example, individual cardholders may register for participation by signing up at a Website, through the mail, over the telephone, or the like.

Further, a number of different types of unique identifiers may be used to identify participating cardholders. For example, in some embodiments, the cardholder's payment card account may be used to identify each participant. As another example, a system-generated identifier may be used. As a still further example, the cardholder's social security number, tax identifier, telephone number, or other information may be used, so long as the identifier may reliably be used to uniquely identify each cardholder participating in a pooled rewards program.

Processing continues at 204 where one or more merchant reward programs are identified that the cardholder participates in. Continuing the illustrative example introduced above, the BigBank cardholder is a participant in a coffee loyalty program, a pharmacy program, a supermarket program and a donut store program. Details of each of these programs are provided at 204. The details of each of the programs may be provided in a number of different ways. For example, a database extraction process may be performed in which participating merchants provide a database of existing customers, and a process may be performed to extract those customers who are participants in the pooled rewards program. In some embodiments, customers may identify each of their programs by entering the information over a Web interface, via mail, or over by telephone. Those skilled in the art will recognize that other techniques for matching information from merchant rewards programs and the pooled reward database may be used to associate merchant reward program information with the customer information in the pooled rewards database. Processing at 204 results in a database structure for each participating customer that includes their unique customer identifier, their pooled rewards account information, and their associated merchant reward program details.

Processing continues at 206 where merchant reward program point conversion rules are created. For example, each merchant reward program may specify a conversion rule used to convert the value of each merchant reward program point to either a dollar equivalent (e.g., 1 point is equal to $0.10) or a pooled reward point equivalent (e.g., 1 merchant point is equal to 1 pooled reward point). This information is used to translate between point types so that when a cardholder earns merchant reward program points a conversion may occur to calculate the equivalent number of pooled reward points earned. Further, the conversion may be performed each time a cardholder requests to redeem reward points so that the cardholder's pooled reward point balance can be decremented appropriately.

The process of FIG. 2 may be performed on continuous basis as additional cardholders and/or merchants sign up to participate in the pooled rewards system of the present invention.

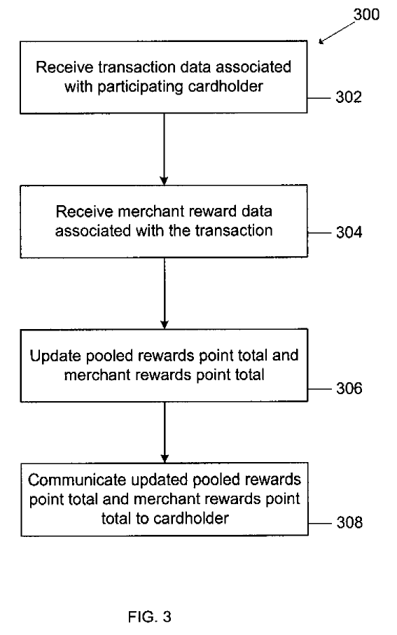

Reference is now made to FIG. 3, where a flow diagram illustrating a pooled rewards transaction process 300 pursuant to some embodiments is shown. Process 300 may be performed using the system of FIG. 1, for example.

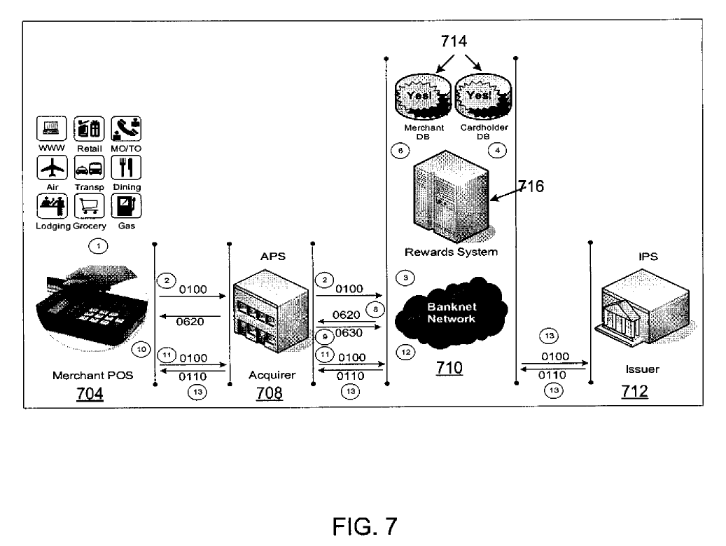

Process 300 begins at 302 where pooled rewards system 116 receives transaction data associated with a participating cardholder. For example, the transaction data may be payment transaction data originating from a merchant POS 104 when a cardholder presents a payment card to complete a purchase transaction at a merchant that has a rewards program participating in the pooled rewards system of the present invention. As in a traditional payment card transaction, the merchant POS causes a payment card authorization request to be generated that includes details of the transaction (including the cardholder's payment card account number, the amount of the purchase, and details about the merchant). In some embodiments, (which will be discussed in further detail below in conjunction with FIG. 7, the merchant systems may append merchant reward program details to the authorization request message (e.g., including details about the cardholder's current reward point balance in the merchant reward program, and the number of merchant reward points earned in the current transaction). In other embodiments, a standard authorization request is generated, and no merchant reward program details are appended to the authorization request.

The authorization request is forwarded from the merchant systems to a merchant acquirer 108 and then routed to the authorization systems 110 for authorization processing. Authorization systems 110 cause the authorization request to be routed to the appropriate issuer 112 for transaction approval, and an authorization response message is returned to the merchant POS to complete the transaction. Pursuant to embodiments of the present invention, the authorization systems 110 also determine whether the transaction involves a customer who is a participant in the pooled rewards program (step 302 of FIG. 3). Processing continues at 304 where merchant reward data associated with the transaction is received. In some embodiments, the merchant reward data is received in the authorization request (e.g., substantially in real time with the transaction). In some embodiments, the merchant reward data is received on a batch basis (e.g., in a nightly or other regularly scheduled batch) directly from a merchant system (e.g., such as the merchant rewards program data source 118 of FIG. 1).

Processing continues at 306 where pooled rewards system 116 parses the merchant rewards program data to cause the pooled rewards database 114 to be updated with the pooled rewards point total and merchant rewards point total associated with the cardholder. For example, if the cardholder completes a purchase transaction at the coffee chain, the coffee chain will provide data identifying the number of coffee chain reward points earned in the transaction and data identifying the cardholder's total coffee chain reward point balance after the transaction. This information is associated with the cardholder's unique identifier and the cardholder's pooled reward point balance is updated in the pooled rewards database 114. Further, the pooled rewards database 114 is updated to reflect the current point balance the cardholder has in the coffee chain's reward program.

Processing continues at 308 where the pooled rewards system 116 operates to communicate the updated pooled rewards point total and the merchant rewards point total to the cardholder. In some embodiments, this communication may take place during the purchase transaction by inserting the rewards point details into the authorization response message before it is returned to the merchant POS systems 104. In this manner, the cardholder may receive a receipt or other messaging identifying the cardholder's current pooled reward point balance and merchant reward program point balance. In some embodiments, the communication at 308 is performed after a transaction has taken place. For example, a Web site accessible by the cardholder may provide the cardholder with access to the updated pooled rewards point balance and the updated merchant reward program point balance. As another example, the cardholder may receive details about the pooled rewards point balance and the merchant reward program point balance in a regular cardholder statement prepared by (or on behalf of) the issuer. Those skilled in the art will appreciate that other forms of communicating the balances may be used. In this manner, a cardholder who participates in the pooled rewards program pursuant to the present invention may quickly and accurately receive information about their account balances, even if the cardholder participates in a number of merchant reward programs.

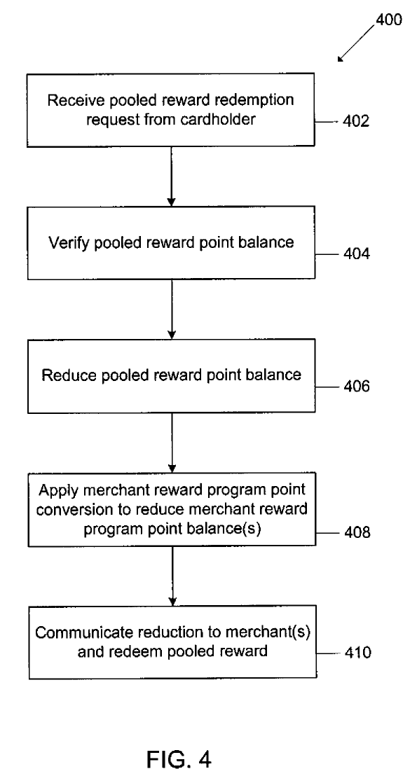

Reference is now made to FIG. 4, which is a flow diagram illustrating a pooled rewards redemption process 400 pursuant to some embodiments. Again, process 400 is performed under control of pooled rewards system 116 in communication with pooled rewards database 114 and other devices or entities of FIG. 1. Process 400 begins at 402 where the system receives a pooled reward redemption request from a participating cardholder. In some embodiments, a cardholder may request to redeem pooled reward points in a number of different ways, including, for example: during a transaction at a participating merchant POS device, over the Internet, by telephone, by mail, or the like. In some embodiments, a redemption request includes information identifying the cardholder, the number of points to redeem, and details of the desired redemption (e.g., such as a product from a rewards catalog, etc.).

Processing continues at 404 where pooled rewards system 116 verifies that the pooled reward point balance is sufficient to complete the requested redemption. For example, this includes locating the customers unique identifier and retrieving one or more database records from pooled rewards database 114 and comparing the current pooled rewards point balance with the requested redemption amount. If the cardholder has sufficient pooled reward points available, processing continues to 406. If there are insufficient points available, a message informing the customer may be generated and transmitted or presented to the customer.

Processing at 406 includes reducing the customer's current pooled reward point balance in the amount of the points redemption. Processing continues at 408 where one or more merchant reward program point conversions take place to convert the number of pooled reward points redeemed to merchant reward points. Processing includes reducing one or more of the merchant reward program point balances by an appropriate amount. For example, in some embodiments, when pooled reward points are redeemed, each of the merchant reward point balances associated with the customer's pooled reward account are reduced evenly. As a specific illustrative example, if the cardholder is redeeming 1000 pooled reward points, and has five (5) merchant reward accounts associated with her pooled reward account, all five (5) merchant reward accounts may be reduced by the equivalent of 200 pooled reward points. Other apportionment rules may also be established. For example, the cardholder may specify that reward points from a specific merchant reward account be used first. Those skilled in the art will appreciate that a number of other apportionment rules may also be established, by the cardholder, by merchants, by the issuer and/or by the pooled rewards system.

Once the pooled rewards point balance has been reduced, and each of the relevant merchant reward point balance(s) have been reduced, processing continues at 410 where the amount of the reduction (and any other relevant information needed or desired by the merchants) is communicated to the merchant reward systems so that each merchant reward system affected by the redemption may update their systems to reflect the reduction.

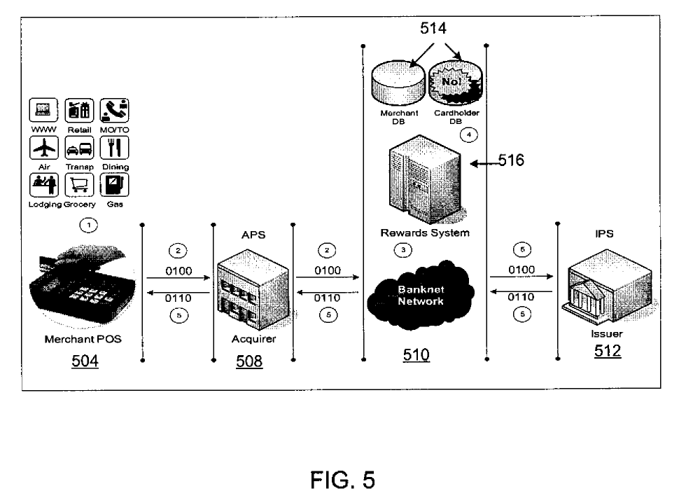

Pursuant to some embodiments, not all merchants, and not all cardholders will be participants in the pooled rewards program. As a result, transactions pursuant to some embodiments may proceed differently, depending on whether the transaction involves (1) a participating merchant, but not a participating cardholder, (2) a participating cardholder, but not a participating merchant, or (3) both a participating merchant and a participating cardholder. FIGS. 5-7 illustrate different processing for each of these three situations.

Reference is now made to FIG. 5, where a block diagram illustrating a pooled rewards system 500 and transaction flow is shown pursuant to some embodiments. In particular, system 500 represents the situation where a non-participating cardholder is making a purchase at a participating merchant location (that is, the merchant has agreed to participate in the pooled rewards system of the present invention).

The transaction of FIG. 5 begins at item (1) when the payment cardholder makes a purchase and a transaction message is created at the merchant's POS terminal 504. The process continues at (2) where the POS terminal 504 creates and transmits an authorization message (shown as a “0100” message) to the authorization systems 510 through the acquirer systems 508. Processing continues at (3) where the authorization systems 510 receives the 0100 message, and processes the message as usual. Processing continues at (4) where the pooled rewards system 516 evaluates the payment card account number (contained in the 0100 message) to determine if the payment card account holder is a participant in the pooled rewards system (e.g., by identifying information in the primary account number contained in the 0100 message, and performing a database look-up of a cardholder database or table 514).

Pursuant to some embodiments of the present invention, processing at (4) includes consulting the pooled rewards database 514 which includes a database or table of payment card holders who are participants in rewards programs, segmented, in some embodiments, by issuer. In some embodiments, the database 514 includes each participant's current balance in their pooled reward accounts, their associated merchant reward program accounts, and a dollar equivalency of the rewards balance. In some embodiments, each cardholder's pooled rewards balance in the database 514 are updated after each transaction (e.g., the balance is incremented or decremented based on each transaction). In some embodiments, the cardholder's pooled rewards balance (and associated merchant reward program balance(s)) are updated on a batch basis after completion of the transaction.

Pursuant to some embodiments, a conversion is also applied prior to updating the pooled rewards balance and any associated merchant reward program balance(s). As discussed above, each merchant may specify a conversion ratio or formula. In other embodiments which involve issuer-funded rewards, the pooled rewards database 514 may also include issuer specific logic for defining rewards points valuation (e.g., 1 dollar purchased is equivalent to X reward points). In some embodiments, the pooled rewards database 514 includes issuer specific logic for defining dollar equivalency (e.g., 1 reward point is equivalent to Y dollar amount). Pursuant to some embodiments, data in the pooled rewards database 514 (including the tables or databases with cardholder and merchant information) are provided from data input or received from each participating issuer. This information may be received on a periodic basis or, in some embodiments, substantially in real-time.

In the transaction shown in FIG. 5, processing continues at item (5) where a determination is made that the cardholder is not a rewards program participant (e.g., the payment card account number or a corresponding unique customer identifier is not found in the pooled rewards database 514). As a result, the transaction is processed as a normal payment card transaction and the authorization 0100 message is passed (as normal) to the issuer for authorization. The issuer 512 either approves or declines the transaction (as normal) and responds with an authorization response message 0110. The authorization systems 510 pass the authorization response message 0110 back to the merchant POS 504 and the transaction concludes, and no rewards information is updated in the pooled rewards database 514.

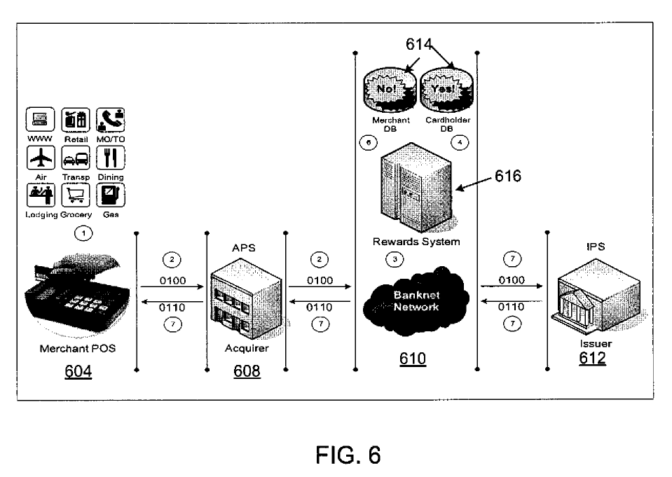

Reference is now made to FIG. 6, where a transaction flow is shown in which the merchant at which a payment card transaction is conducted is not a participant in the pooled rewards program, but the cardholder is a participant in the program. Processing is similar to the processing of FIG. 5 in that the merchant POS 604 generates an authorization request message 0100 which is routed to the authorization systems 610. At message (6), however, when the payment card account information is compared to cardholder information contained in the pooled rewards database 614, the pooled rewards system 616 finds that the payment card cardholder is a participant in the pooled rewards system. Once the payment card account holder is found to be a participant, a second look-up is performed to determine if the merchant from which the transaction authorization request message originated is a member of the pooled rewards program.

Pursuant to some embodiments, to allow cardholders to redeem or use points (or dollar equivalents thereof) at a POS, the merchant must be registered or identified as a member of the “merchant coalition” program of the rewards program. To participate, the merchant's POS terminal 604 may be enabled to accept new messages from the payment processing network to allow online rewards activity with the cardholder at the POS terminal 604. Even if the merchant isn't a member of the “merchant coalition” program, in some embodiments, cardholders may still continue to earn and accumulate pooled rewards points by being a member of the issuer's rewards program. That is, as shown in the example transaction of FIG. 6, the cardholder is a participant in the pooled rewards program (and has a unique customer identifier in the pooled rewards database 614), but the merchant is not a participant (and is not shown as a participant in the pooled rewards database 614). As such, the cardholder may still enjoy the accrual of pooled rewards points based on participation in the issuer program, but will not be able to perform online rewards activity from the POS terminal 604 because the merchant is not a participant.

In this example transaction, the merchant (identified by a unique merchant identifier) is not a participant or member of the merchant coalition or the pooled rewards program. As such, the pooled rewards system 616 will cause the transaction to be processed as a normal payment card transaction, and the authorization systems 610 passes the authorization request message to the issuer 612 for decisioning. If the transaction is authorized, the cardholder may earn reward points based on participation in the issuer rewards program (if one exists) which will be updated by the rewards system after the payment transaction is cleared.

Reference is now made to FIG. 7, where a further embodiment of a transaction is depicted pursuant to some embodiments. In the embodiment shown in FIG. 7, a payment cardholder is a participant in the pooled rewards program, and the merchant at which a transaction is conducted is also a participant in the pooled rewards program. That is, the merchant is identified as a participant in the pooled rewards database 714 of the pooled rewards system 716. Further, some or all of the POS terminals 704 used by the merchant are configured with software that parses a new message format (described below) that allows a cardholder to redeem or otherwise use points or discounts in transactions. In some embodiments, the POS devices 704 use Microsoft's Point of Service® software or the like.

The transaction of FIG. 7 commences as in the transactions of FIGS. 5 and 6, where the payment card is presented at a POS terminal 704, and an authorization request message is routed to the authorization systems 710. At (4), the cardholder is identified as participating in the pooled rewards program (e.g., the cardholder has a unique customer identifier in pooled rewards database 714), and at (6), the merchant is identified as participating in the pooled rewards program (e.g., the merchant is identified in the pooled rewards database 714). If the merchant is a participant in the pooled rewards program, the pooled rewards system 716 will create an administrative message (shown as the “0620” message, although those skilled in the art will appreciate that other message identifiers and types may be used) which contains rewards information to be transmitted back to merchant POS terminal 704. In some embodiments, four pieces of information may be populated in the 0620 message: (a) the total accumulated pooled rewards points as of the last transaction cleared, (b) the dollar equivalent assigned to the points as of the last transaction cleared, (c) a discount (% rate or dollar amount) to be applied on the current transaction, and (d) any relevant messaging to be displayed or communicated to the cardholder regarding the rewards transaction.

Pursuant to some embodiments, in such a transaction, rewards are funded by the issuer, and the discount is funded by the merchant (the rate and duration of this funding is negotiated between the issuer and the merchant, as such, in some embodiments, the value in this field could be 0). Within the administrative 0620 message, an identifier may be provided that indicates that the type of the message is a rewards message.

The 0620 message is routed back to the merchant POS terminal 704 and the POS terminal 704 sends an acknowledgement message (shown as the “0630” message) back to the authorization systems 710 (to confirm successful receipt of the 0620 message). At this point, the merchant POS terminal 704 is able to perform on-line rewards activity. For example, depending on the content of the 0620 message, the POS terminal 704 may display an automatic discount (such as a % rate, or a dollar amount) that will be applied to the current transaction, or the POS terminal 704 may display the cardholder's pooled rewards points balance (in points and/or dollar equivalency) that can be applied to the current transaction. Pursuant to some embodiments, the amount can be up to (but not more than) the current pooled rewards dollar balance.

The cardholder is then prompted, at the POS terminal 704, for the rewards dollar amount to be used or applied to the current transaction. The POS terminal 704 may calculate the net amount (e.g., the original transaction amount less the discount less the rewards dollars to be applied, plus any applicable taxes). The merchant POS terminal 704 then creates a new authorization request (“0100” message) with the final transaction amount and populates one or more fields of the 0100 message with: (a) a reward flag to indicate that the transaction has been processed through the rewards system engine, (b) one or more product SKUs, and (c) the amount of the pooled reward dollars used by the cardholder in the transaction. The merchant POS terminal 704 than submits the 0100 message and it is routed to the authorization systems 710.

At (12), the authorization systems 710 receive the 0100 message and parse the message to identify the existence of the new fields with the pooled reward information. Since the reward flag is set, the 0100 message is not routed through the pooled rewards system 716 again; instead, the 0100 message is passed to the issuer 712 for final authorization. The rewards system will update the cardholder's pooled reward account balance after the transaction has cleared.

At (13), the authorization systems 710 forward the 0100 message to the issuer 712 and an authorization response message 0110 is returned from the issuer 712 and routed back to the merchant POS terminal 704 to complete the transaction. In this manner, embodiments allow cardholders to access and utilize pooled rewards points at the point of sale.

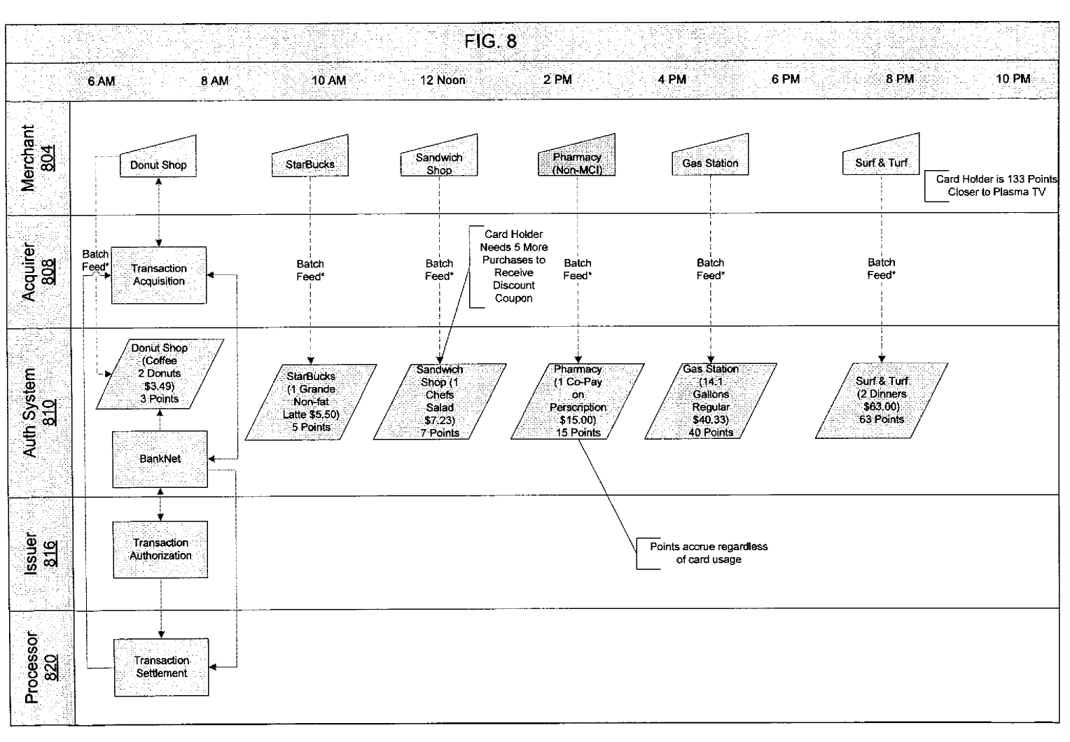

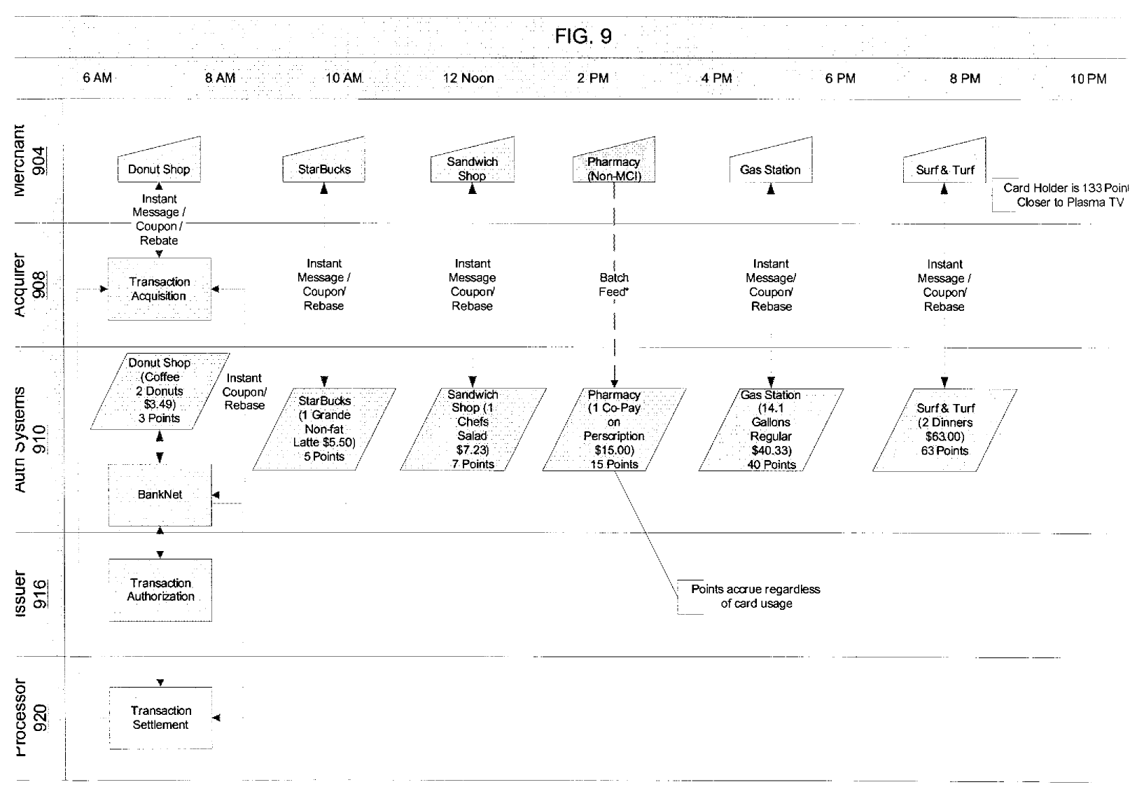

As discussed above, features of some embodiments may be utilized in a near “real-time” environment (such as described in conjunction with FIG. 7) or in a “batch” or regular updating environment where merchant reward information is used to update the pooled rewards database on a regular basis. An understanding of these various embodiments may be aided by reference to FIGS. 8 and 9. FIG. 8 is a swim lane diagram depicting a “day in the life” of a cardholder that is a participant in the pooled rewards program pursuant to embodiments of the present invention. In the embodiment depicted in FIG. 8, the pooled rewards program is operating in a “batch” embodiment. As shown in FIG. 8, the cardholder may use her card throughout the day at a variety of different merchant locations, each of which has different reward program rules and conditions.

In the embodiment depicted, each of the merchants are also participants in the pooled rewards program, and submit reward transaction information to the pooled rewards system on a batch basis. For example, at 6 am, the cardholder visits a donut shop and purchases coffee and two donuts for a total purchase price of $3.49. This transaction information is processed as a normal payment card transaction, that is, a standard authorization request message is transmitted from the merchant 804, to the acquirer 808 and on to the authorization systems 810 for authorization. Later, in a batch process, the merchant transmits purchase information associated with a number of purchase transactions, to the authorization system 810 (or, to a pooled rewards system associated with the authorization system 810) for processing. The pooled rewards system (such as the pooled rewards system 116 of FIG. 1) processes the batch data to identify those transactions that involved cardholders participating in the rewards program. The batch data also includes merchant rewards data from the merchant (e.g., such as information indicating that the cardholder earned 3 reward points in the donut store's reward program). This information is used to update the cardholder's pooled reward account information in the pooled rewards database.

In this manner, the cardholder can shop at a variety of merchants (such as those indicated in FIG. 8, for example) and earn pooled reward points throughout the day. Each of the merchants that is a participant in the pooled rewards program uploads or transmits payment information and rewards information in batch files, so that the cardholder's pooled rewards information is updated based on each individual transaction. The cardholder enjoys the ability to pool rewards from a variety of different merchants, while using a single payment card throughout the day.

FIG. 9 is a further swim lane diagram depicting a “day in the life” of a cardholder that is a participant in the pooled rewards program pursuant to embodiments of the present invention. In the embodiment depicted in FIG. 9, the pooled rewards program is operating (at least partially) in an online or substantially real-time embodiment, and a cardholder is able to receive instant coupons or rebates during a transaction based on participation in the pooled rewards system. As shown in FIG. 9, the cardholder may use her card throughout the day at a variety of different merchant locations, each of which has different reward program rules and conditions.

In the embodiment depicted, each of the merchants are also participants in the pooled rewards program, and submit reward transaction information to the pooled rewards system on either a batch basis or substantially in real time. For example, at 6 am, the cardholder buys coffee and donuts at a donut shop. In this embodiment, the donut shop is able to transmit payment information as well as reward program information to the authorization systems 910 (e.g., as described above in conjunction with FIG. 7) so that a pooled rewards system associated with the authorization system 910 is able to update pooled rewards database substantially in real time. In this manner, the pooled rewards system, acting in conjunction with the authorization systems 910, is able to transmit rewards-related information back to the merchant during the purchase transaction. For example, coupons, rebates, and other rewards messaging may be transmitted back to the merchant point of sale location so that the cardholder may enjoy rewards during the transaction (or at least be informed of the number of pooled reward points and/or merchant reward points earned during the transaction). Similar transactions can occur throughout the day.

In some embodiments, a combination of the real-time and batch processes may be used, such that some merchants operate in batch mode, and others operate substantially in real time.

Embodiments of the present invention provide a number of features and advantages including, for example: 1) the pooling (collecting) of payment cardholder information, payment transaction information, and merchant reward program information to enable cardholders to use their payment cards to identify whether they are a member of a merchant reward program; 2) the use of existing payment network merchant connections, payment card pre-authorization and card authorization technology to interact with merchant POS devices for the purpose of merchant reward program verification and validation as well as the identification of general and specific merchant and product/service rebates, coupons and discounts for which the cardholder is eligible at the POS; 3) the recording of general and specific merchant and product/service rebates, coupons, and discount on the cardholder sales receipt; 4) using existing payment processing network technology infrastructure, the electronic and automatic verification, validation and settlement of product/service rebates, coupons and discounts at the POS between merchants, manufactures, and cardholders to eliminate the need for either cardholder mail-in or batch coupon settlement between merchant and manufacturer; 5) the use of reward points as a form of cardholder payment currency (“reward redemption”) at the POS; 6) the creation of a reward point financial or currency, conversion method and software to normalize the reward points value between merchant reward programs for the benefit of both cardholders and merchants; 7) the creation of POS add-in software to be licensed and distributed to merchants to enable merchant POS devices to leverage the features as described above. The result is a system that allows increased participation in rewards programs. Cardholders do not need to carry multiple rewards cards—they are all consolidated in a database keyed by the cardholder's payment card.

In some embodiments, payment cardholders may “opt-in” to participate in the merchant reward program via a separate Internet-based application which will allow the payment cardholder to selectively enter and identify the reward programs to be included in their reward portfolio.

In some embodiments, multiple rewards or discounts may be applied to a single transaction based on individual items purchased in the transaction. For example, once the transaction has been analyzed by the rewards system, one or more 0620 messages may be sent to the merchant POS terminal so that the rebates, coupons and discounts may be presented to the cardholder for use in completing the transaction.

In some embodiments, both general and specific rebates, coupons and discounts will be printed on the cardholder's sales receipt in a manner that will make it easy for the cardholder to determine where and how the rebates, coupons and discounts have been applied to the sales ticket. For example, specific rebates, coupons and discounts may appear on the sales ticket in the line following the item purchased.

Pursuant to some embodiments, the system of the present invention allows the electronic and automatic verification, validation and settlement of product/service rebates, coupons and discounts at the POS between merchants, manufactures, and cardholders to eliminate the need for either cardholder mail-in or batch coupon settlement between merchant and manufacturer

Pursuant to some embodiments, the rewards system will automate the submission of manufacturer rebate mail-in as a proxy for the cardholder, since the POS transaction represents a cardholder “proof of purchase”. Further, embodiments may automate the settlement of merchant and manufacturer coupon settlement since the POS transaction also represents a cardholder “proof of purchase”.

The reward point conversion method and software will enable cardholders to accrue their rewards points for multiple merchants in separate pools, and then potentially to combine their reward points at the POS of any merchant that participates in the rewards program. The rewards system will set and maintain the reward point exchange rates with the consent of the participating merchants.

Although the present invention has been described with respect to example embodiments thereof, those skilled in the art will appreciate that various substitutions or modifications may be made without departing from the spirit and scope of the present invention. For example, the processes have been described with a “payment association” such as MasterCard as the operating entity. Those skilled in the art will appreciate that other entities may also operate some or all of the process steps (including, for example, closed payment networks, regional or local payment networks, or the like). Further, a “payment card” or “credit card” has been discussed. Those skilled in the art will appreciate that embodiments may be used in conjunction with other payment devices such as stored value cards, gift cards, ACH transactions, checks, debit cards, or the like.

What is claimed is:

1. A method, comprising:
receiving, from a point of interaction associated with a merchant, an authorization request message identifying a requested purchase transaction, said authorization request message including data identifying a payment account identifier and a purchase amount;
authorizing said purchase transaction;
receiving, from said merchant, merchant reward data associated with said purchase transaction; and
updating a pooled rewards database entry associated with said consumer.

2. The method of claim 1, further comprising:
determining that said payment account identifier is associated with a consumer participating in a pooled rewards program.

3. The method of claim 1, further comprising:
determining that said merchant is a participant in said pooled rewards program.

4. The method of claim 2, wherein said determining that said payment account identifier is associated with a consumer participating in a pooled rewards program is performed based on information in said authorization request and substantially in conjunction with said authorizing.

5. The method of claim 2, wherein said determining that said payment account identifier is associated with a consumer participating in a pooled rewards program is performed based on batch data received from said merchant after completion of said purchase transaction.

6. The method of claim 4, further comprising:
communicating information identifying said updated pooled rewards database entry to said consumer during said purchase transaction.

7. The method of claim 5, further comprising:
communicating information identifying said updated pooled rewards database entry to said consumer after said purchase transaction.

8. The method of claim 1, wherein said updating said pooled rewards database entry comprises:
receiving merchant reward information identifying a merchant reward point total associated with said transaction and applying a conversion factor to calculate a pooled reward point total associated with said transaction.

9. The method of claim 2, further comprising:
transmitting an administrative message to said merchant point of interaction, said administrative message containing information identifying the consumers current pooled reward point information;
receiving, in response to said administrative message, an acknowledgement message confirming receipt of said administrative message;
receiving, from said merchant point of interaction, an updated authorization request, said updated authorization request including an updated purchase amount based on at least one of: (i) a discount amount applied to the original purchase amount, and (ii) a reward point redemption amount applied to the original purchase amount; and
authorizing said purchase transaction based on said updated authorization request.

10. The method of claim 9, further comprising:
updating said pooled rewards database entry based on said updated authorization request.

11. The method of claim 1, wherein said pooled rewards database entry includes information identifying at least one of: a unique consumer identifier associated with said consumer, a pooled reward point total, and at least a first merchant reward program point total.

12. An apparatus, comprising:
a processor; and
a memory in communication with the processor, the memory storing program instructions, the processor operative with the program instructions to:
receive, from a point of interaction associated with a merchant, an authorization request message identifying a requested purchase transaction, said authorization request message including data identifying a payment account identifier and a purchase amount;
authorize said purchase transaction;
receive, from said merchant, merchant reward data associated with said purchase transaction; and
update a pooled rewards database entry associated with said consumer.

13. The apparatus of claim 12, wherein the processor is further operative with the program instructions to:
determine that said payment account identifier is associated with a consumer participating in a pooled rewards program.

14. The apparatus of claim 13, wherein the processor is further operative with the program instructions to:
transmit an administrative message to said merchant point of interaction, said administrative message containing information identifying the consumers current pooled reward point information;
receive, in response to said administrative message, an acknowledgement message confirming receipt of said administrative message;
receive, from said merchant point of interaction, an updated authorization request, said updated authorization request including an updated purchase amount based on at least one of: (i) a discount amount applied to the original purchase amount, and (ii) a reward point redemption amount applied to the original purchase amount; and
authorize said purchase transaction based on said updated authorization request.

15. The apparatus of claim 14, wherein the processor is further operative with the program instructions to:
update said pooled rewards database entry based on said updated authorization request.

16. The apparatus of claim 15, wherein said pooled rewards database entry includes information identifying at least one of: a unique consumer identifier associated with said consumer, a pooled reward point total, and at least a first merchant reward program point total.

17. A rewards system, comprising:
a point of interaction generating a transaction authorization request message associated with a transaction, the request message including a purchase amount, a payment account identifier, and a merchant identifier;
an authorization system, in communication with the point of interaction to receive the transaction authorization request message and authorize said transaction;
a pooled rewards system, associated with said authorization system, and controlling a pooled rewards database, said pooled rewards database storing information identifying participating consumers, participating merchants, pooled reward point balances, and merchant reward program point balances; the pooled rewards system operative with said authorization system to
determine that a consumer associated with said payment account identifier and a merchant associated with said merchant identifier are participants in a pooled rewards program; and
update a record associated with said consumer to reflect a number of merchant reward point earned by said transaction and a corresponding number of pooled reward points earned by said transaction.

18. The rewards system of claim 17, wherein said pooled reward systems is further operative with said authorization system to:
transmit an administrative message to said point of interaction, during said transaction, to inform said consumer of at least one of said pooled reward points and said merchant reward points.
